(19) United States
(12) Patent Application Publication
(10) Pub. No.: US 2001/0014125 A1
(43) Pub. Date: Aug. 16, 2001

(54) Motion image coding device and decoding device

(76) Inventor: Yukio Endo, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/782,043

(22) Filed: Feb. 14, 2001

(30) Foreign Application Priority Data
Feb. 15, 2000 (JP) 36687/2000

(51) Int. Cl. H04N 7/12

(52) U.S. Cl. 375/240.16; 375/240.2

(57) ABSTRACT

It is an object of the present invention to provide a motion image coding and decoding devices which can make it possible to perform efficient motion image transmission even though a large inter-frame difference regardless of a zero motion vector. For respective small divided blocks, motion vectors are detected by an ME from motion image input data and local decoded motion image data of a previous frame stored in a frame memory. A GE detects a luminance gain which is a coefficient multiplied to luminance signal pixels of the local decoded motion image data of the previous frame, at which a sum of difference absolute values between the motion image input data and the local decoded motion image data is minimum. When the detected motion vector is a zero vector, gain-compensated motion image data obtained such that motion-compensated motion image data subjected to motion compensation by an MC is subjected to gain compensation by a luminance gain is generated. With reference to the gain-compensated motion image data, an inter-frame differential data is generated to delete time redundancy. The luminance gain and the motion vector are subjected to static information compression by a variable length coder to notify a motion image decoding device of the luminance gain and the motion vector.

The present invention relates to a motion image coding device and a decoding device for transmitting a motion image signal and, a motion image coding device and a decoding device for transmitting a motion image signal at a high efficiency on the basis of a motion vector detected between an input motion image signal and a motion image signal of a previous frame.

In recent years, Integrated Services Digital Network (to be referred to as an ISDN hereinafter) for making it possible to provide digital data transmission or an IP (Internet Protocol) network for transmitting packeted data has widely spread. By these ISDN and IP networks, together with advancing of an information processing technique and increasing of the processing speed, the usage of a transmission system for motion image data such as video communication or remote image monitor has rapidly spread. When motion image data to be transmitted is coded to compress an amount of information in a coding device, preferable image quality can be realized even in a network having a low bit rate. As coding techniques for the motion image data, there is known, for example, techniques employed in International Telecommunication Union-Telecommunication Standardization Sector (to be referred to as ITU-T hereinafter) recommendations H. 261 and H. 263.

The ITU-T recommendations H. 261 and H. 263 mainly regulate digital coding for a color video signal in a television conference system or a television telephone system. More specifically, by using an inter-motion compensative-frame predictive technique and a Discrete Cosine Transform (to be referred to as a DCT hereinafter) technique, an image signal is efficiently coded, and preferable image quality at a relatively low transmission speed and short-time coding and decoding processes are compatible with each other.

In a conventional motion image coding device for coding motion image data, a motion image to be transmitted in motion image input data 10 is divided into predetermined small block units. The motion image input data is input to a motion vector detector (Motion Estimation: to be referred to as an ME hereinafter) and a subtractor. The ME detects a motion vector on the basis of the motion image input data and local decoded motion image data of a previous frame stored in a frame memory. This motion vector is two-dimensional motion information representing a spatial difference between a pixel value of a present frame and a pixel value of a previous frame. The motion vector represents a position to which an image in a certain frame moves in the next frame. The local decoded motion image data and the motion vector in the previous frame are input to a motion compensator (Motion Compensation: to be referred to as an MC hereinafter). The MC compensates for the local decoded motion image data in the previous frame with the motion vector to output motion-compensated motion image data. The motion-compensated motion image data is input to a subtractor and an adder.

The subtractor calculates a difference between the motion image input data and the motion-compensated motion image data. The calculated inter-frame differential data is supplied to a DCT circuit. The DCT circuit performs orthogonal transform (to be referred to as a DCT hereinafter) to the inter-frame differential data. For this reason, DCT data transformed as a coefficient of a cosine function of each frequency component is obtained from the inter-frame differential data. It is well known that the coefficients obtained by the DCT are concentrated around a coefficient of a specific frequency component such as a DC component. Therefore, when the DCT data is quantized by a quantizer, only the concentrated coefficients around the coefficient of the frequency component remain. The quantized data quantized by the quantizer is input to an inverse quantizer and a variable length coder.

The inverse quantizer performs inverse quantization obtained by inverting the quantization performed by the quantizer to generate inversely quantized data corresponding to the DCT data. The inversely quantized data is supplied to an inverse DCT circuit. This inverse DCT circuit performs inverse DCT corresponding to the DCT performed by the DCT circuit to generate inverse DCT data. The inverse DCT data is input to an adder. The adder adds the inverse DCT data and the motion-compensated motion image data to each other to generate local decoded motion image data. The local decoded motion image data is input to a frame memory. The local decoded motion image data is output as local decoded motion image data in the previous frame at the next frame timing.

The variable length coder performs static information compression on the basis of the quantized data and the motion vector to output coded output data.

According to the above configuration, only the difference between the frames is calculated with reference to the motion-compensated motion image data. In this manner, redundancy in the direction of a time axis of information to be transmitted is reduced.

In addition, in a conventional motion image coding device, DCT is performed to the inter-frame differential data by the DCT circuit. The characteristics of motion image data in which cosine functions of transformed frequency components are related to each other are used. When the quantizer performs quantization, the frequency components of cosine functions which are decoded without adversely affecting an image are removed. For this reason, the amount of the DCT data to be transmitted is further reduced. The variable length coder performs static information compression to the DCT data and the motion vector output from the quantizer and transmits the compressed DCT data and the compressed motion vector. In this manner, the redundancy in the direction of the spatial axis of information to be transmitted is reduced.

The coded output data coded as described above is transmitted through, e.g., the ISDN or the IP network and received by a motion image decoding device. The motion image decoding device performs variable length decoding, inverse quantization, inverse DCT, and motion compensation by a procedure reverse to the procedure of a motion image coding device to perform decoding to a received motion image.

The motion image coding and decoding devices described above are variably proposed. For example, Japanese Unexamined Patent Publication No. 5-95545 discloses a technique for adaptively switching a first mode which divides each block by two to make it possible to perform motion predictive of one from the other and a second mode which does not divide each block by two in high-efficient coding performed by an image of MPEG (Moving Picture Experts Group).

Japanese Unexamined Patent Publication (JP-A) No. 7-30896 discloses a technique for detecting a difference motion vector which is a difference between a motion vector detected for each block and a motion vector of the same block in the previous frame to change coding depending on the magnitude of the difference motion vector. In this manner, high-efficient coding can be realized.

In the conventional motion image coding device as described above, a motion vector is calculated from the motion image input data and the local decoded motion image data of the previous frame to obtain a difference between the motion vector and motion image data of the previous frame to which motion compensation is performed by the motion vector. For this reason, even though an object moves, an inter-frame difference is minimized, and an amount of information to be transmitted can be considerably reduced.

However, a camera motion image under illumination obtained by a fluorescent having, e.g., a flicker (to be referred to as a flicker hereinafter), an inter-frame difference signal caused by a change in luminance with time is generated without moving the object. Here, the change in luminance caused by the flicker will be described.

FIG. 2 is a diagram showing an example of a camera motion image under illumination obtained by a fluorescent having a flicker. A camera motion image data 50 is divided into predetermined blocks, and is divided into 8×8 blocks in FIG. 2. The camera motion image data 50 includes an object 51 which is a triangle shape. FIG. 2 shows a case in which a stripe-shaped flicker 52 is generated. At this time, since the stripe-shaped flicker 52 partially overlaps the object 51, an image obtained this state is not correct.

FIG. 3 shows an example of a camera motion image under illumination obtained by a fluorescent in a previous frame of FIG. 2. In FIG. 3, a stripe-shaped flicker vertically moves with time. The object 51 does not move in a local decoded motion image data 55 of the previous frame. A position where a stripe-shaped flicker 56 is generated is different from that shown in FIG. 2. More specifically, these positions are different from each other in that the stripe-shaped flicker partially overlaps the object 51. Therefore, when the same blocks 57 in the camera motion image data 50 in FIG. 2 and the local decoded motion image data 55 of the previous frame are interested, although the motion vector of the object 51 is zero, a large change in luminance. According to this change, a large inter-frame difference signal is generated.

The generation of the larger inter-frame difference signal unit that an effect of transmission information compression performed by motion compensation cannot be expected although the object does not move. Therefore, it is impossible to efficiently transmit a motion image signal.

### SUMMARY OF THE INVENTION

It is an object of the present invention to provide motion image coding and decoding devices for making it possible to perform efficient motion image transmission even though a large inter-frame difference is generated regardless of a zero motion vector.

According to a first aspect of the present invention, a motion image coding device includes (A) a frame memory for storing motion image data of a previous frame, (B) motion vector detector for detecting a motion vector representing a spatial difference of pixel values between frames from input motion image data and the motion image data of the previous frame stored in the frame memory, (C) gain detector for detecting a gain to be compensated to the motion image data of the previous frame such that changes in luminance of pixels between the frames of the input motion image data and the motion image data of the previous frame are minimum, (D) gain compensator for performing gain compensation to the motion image data of the previous frame on the basis the gain detected by the gain detector when the motion vector detected by the motion vector detector is a zero vector, (E) inter-frame differential data generator for generating inter-frame differential data which is a difference between the input motion image data and the motion image data to which gain compensation is performed by the gain compensator, and (F) coder for coding the inter-frame differential data generated by the inter-frame differential data generator, the motion vector, and the gain to transmit the coded inter-frame differential data, the coded motion vector, and the coded gain. Hereinafter, the motion image data to which gain compensation is performed is called as gain-compensated motion image data.

More specifically, the gain detector detects the gain to be compensated to the motion image data of the previous frame is detected such that the changes in luminance of the pixels between the frames of the input motion image data and the motion image data of the previous frame stored in the frame memory are minimum. When the motion vector detected by the motion vector detector is a zero vector, the gain compensator performs gain compensation to the motion image data of the previous frame on the basis of the detected gain. The inter-frame differential data generator generates the inter-frame differential data which is a difference between the input motion image data and the motion image data to which gain compensation is performed by the gain compensator. The inter-frame differential data, the motion vector, and the gain are coded. The coded inter-frame differential data, the coded motion vector, and the coded gain are transmitted to a decoding device.

According to a second aspect of the present invention, a coding device includes (A) a frame memory for storing motion image data of a previous frame, (B) motion vector detector for detecting a motion vector representing a spatial difference of pixel values between frames from input motion image data and the motion image data of the previous frame stored in the frame memory, (C) gain detector for detecting a gain to be compensated to the motion image data of the previous frame such that changes in luminance of pixels between the frames of the input motion image data and the motion image data of the previous frame are minimum, (D) motion compensator for performing motion compensation to the motion image data of the previous frame on the basis of the motion vector detected by the motion vector detector, (E) gain compensator for performing gain compensation to the motion image data to which motion compensation is performed by the motion compensator on the basis the gain detected by the gain detector, (F) inter-frame differential data generator for generating inter-frame differential data which is a difference between the input motion image data and the motion image data to which gain compensation is performed by the gain compensator, and (G) coder for coding the inter-frame differential data generated by the inter-frame differential data generator, the motion vector, and the gain to transmit the coded inter-frame differential data, the coded motion vector, and the coded gain. Hereinafter, the motion image data to which motion compensation is performed is called as motion-compensated motion image data.

The motion vector detector detects the motion vector representing the spatial difference of the pixel values between the frames of the input motion image data and the motion image data of the previous frame. The gain detector detects the gain to be compensated to the motion image data of the previous frame such that the changes in luminance of pixels between the frames are minimum. More specifically, motion compensation is performed by the detected motion vector. Then, The gain compensation to motion-compensated motion image data is performed by the detected gain. In addition, the inter-frame differential data generator generates inter-frame differential data between the input motion image data and the motion-compensated motion image data. The inter-frame differential data, the motion vector, and the gain are coded. The coded inter-frame differential data, the coded motion vector, and the coded gain are transmitted to a decoding device.

In the second aspect, the coding device may further include orthogonal transform unit for performing orthogonal transform of inter-frame differential data and quantization unit for quantizing the transformed data from the orthogonal transform unit. The coder codes the quantized data quantized by the quantization unit, the motion vector, and the gain depending on the generation frequencies thereof to transmit the coded quantized data, the coded motion vector, and the coded gain.

More specifically, the coding device causes the orthogonal transform unit to orthogonally transform the inter-frame differential data and to concentrate the inter-frame differential data on a specific transform coefficient by a high correlation inherent in the motion image data. The inter-frame differential data to which orthogonal transform is performed is quantized. In this manner, spatial redundancy is removed. The inter-frame differential data, the motion vector, and the gain are coded depending on the generation frequencies thereof. In this manner, the spatial redundancy is further removed, and an amount of information to be transmitted can be considerably reduced.

According to a third aspect of the present invention, a decoding device includes (A) a frame memory for storing motion image data of a previous frame, (B) extraction unit for extracting, from input code data, coded motion image data, a motion vector representing a spatial difference of pixel values between the coded motion image data and motion image data of the previous frame, and a gain to be compensated to the motion image data of the previous frame such that changes in luminance of pixels between the coded motion image data and the motion image data of the previous frame are minimum, (C) gain compensator for performing gain compensation to the motion image data of the previous frame on the basis of the gain when the motion vector extracted by the extraction unit is a zero vector, and (D) decode motion image data generator for generating decoded motion image data on the basis of the motion image data to which gain compensation is performed by the gain compensator and the coded motion image data.

More specifically, the extraction unit extracts, from the input code data, the coded motion image data, the motion vector representing a spatial different of pixel values between the coded motion image data and the motion image data of the previous frame stored in the frame memory, and the gain to be compensated to the motion image data of the previous frame such that the changes in luminance of pixels between the coded motion image data and the motion image data of the previous frame are minimum. When the motion vector extracted by the extraction unit is a zero vector, gain compensation to the motion image data of the previous frame is performed on the basis of the gain. Decoded motion image data is generated on the basis of the gain-compensated motion image data and the coded motion image data.

According to a fourth aspect of the present invention, a decoding device includes (A) a frame memory for storing motion image data of a previous frame, (B) extraction unit for extracting, from input code data, coded motion image data, a motion vector representing a spatial difference of pixel values between the coded motion image data and motion image data of the previous frame, and a gain to be compensated to the motion image data of the previous frame such that changes in luminance of pixels between the coded motion image data and the motion image data of the previous frame, (C) motion compensator for compensating for the motion image data of the previous frame on the basis of the motion vector extracted by the extraction unit, (D) gain compensator for performing gain compensation to the motion-compensated motion image data, and (E) decode motion image data generator for generating decoded motion image data on the basis of the gain-compensated motion image data and the coded motion image data.

More specifically, the extraction unit extracts, from the input code data, the coded motion image data, the motion vector representing a spatial different of pixel values between the coded motion image data and the motion image data of the previous frame stored in the frame memory, and the gain to be compensated to the motion image data of the previous frame such that the changes in luminance of pixels between the coded motion image data and the motion image data of the previous frame are minimum.

The motion image data of the previous frame is subjected to motion compensation on the basis of the motion vector extracted by the extraction unit. Gain compensation to the motion-compensated motion image data is performed on the basis of the gain extracted by the extraction unit. Decoded motion image data is generated from the gain-compensated motion image data and the coded motion image data.

In the third and fourth aspects of the present invention, the motion image decoding device may further include inverse quantization unit for inversely quantizing coded motion image data extracted by the extraction unit, and orthogonal inverse transform unit for performing orthogonal transform to the inversely quantized data inversely quantized by the inverse quantization unit. The decode motion image data generator generates decoded motion image data from the motion image data to which orthogonal inverse transform is performed by the orthogonal transform unit and the gain-compensated motion image data.

More specifically, the orthogonal inverse transform unit perform inverse transform to the pixel values of the coded motion image data to which information compression is performed by orthogonal transform and quantization. In addition, inverse quantization is performed to decode the motion image data of the coded inter-frame difference. Decoded motion image data is generated from the motion image data of the decoded inter-frame difference.

In the second aspect of the present invention, the coder in the motion image coding device may code a gain to transmit the coded gain only when the motion vector is a zero vector.

More specifically, since the gain is coded to transmit the coded gain when the motion vector is a zero vector, an amount of information to be transmitted can be further reduced.

Preferably, the coder in the motion image coding device codes the gain in place of the motion vector to transmit the coded gain when the motion vector is a zero vector.

Since the gain is coded in place of the motion vector to transmit the coded gain when the motion vector is a zero vector, an amount of information larger than the amount of information can be further reduced.

### BRIEF DESCRIPTION OF THE DRAWINGS

FIG. 1 is a schematic block diagram showing the configuration of a conventional motion image coding device;

FIG. 2 is a diagram for explaining an example of a camera motion image under illumination obtained by a fluorescent having flicker;

FIG. 3 is a diagram for explaining an example of a camera motion image under illumination obtained by a fluorescent having a flicker in a previous frame in FIG. 2;

FIG. 4 is a schematic block diagram showing the configuration of a motion image coding device according to an embodiment of the present invention.

FIG. 5 is a schematic block diagram showing the configuration of a motion image decoding device according to an embodiment of the present invention.

FIG. 6 is a schematic block diagram showing the configuration of a motion image coding device according to another embodiment of the present invention.

### DESCRIPTION OF THE PREFERRED EMBODIMENTS

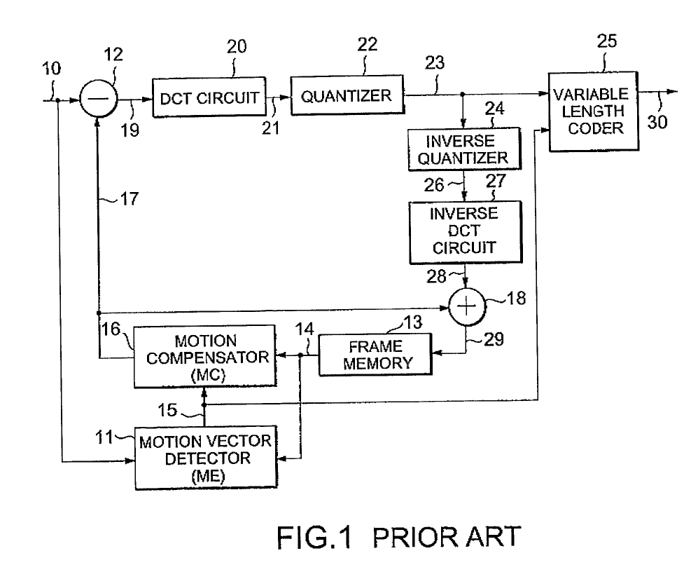

A conventional motion image coding device will be described below with reference to FIGS. 1 to 3. A motion image input data 10 in FIG. 1 is obtained by dividing a motion image to be transmitted into predetermined small block units. The motion image input data 10 is input to a motion vector detector (Motion Estimation: to be referred to as an ME hereinafter) 11 and a subtractor 12. The ME 11 extracts a motion vector 15 on the basis of the motion image input data 10 and a local decoded motion image data 14 of a previous frame stored in a frame memory 13. The motion vector is two-dimensional motion information representing a spatial difference of pixel values between a current frame and a previous frame, and represents a specific position to which an image in a certain frame in the next frame. The local decide motion image data 14 of the previous frame and the motion vector 15 are input to a motion compensator (Motion Compensation: to be referred to as an MC hereinafter) 16. The MC 16 compensates for the local decoded motion image data of the previous frame by the motion vector 15, and outputs a motion-compensated motion image data 17. The motion-compensated motion image data 17 is input to the subtractor 12 and an adder 18.

The subtractor 12 calculates the difference between the motion image input data 10 and the motion-compensated motion image data 17. A calculated inter-frame differential data 19 is supplied to a DCT circuit 20. The DCT circuit 20 performs orthogonal transform (to be referred to as DCT hereinafter) to the inter-frame differential data 19. In this manner, DCT data 21 transformed as coefficients of cosine functions of frequency components is obtained from the inter-frame differential data 19. It is well known that a natural image has close frequency components for respective pixels. The coefficients obtained by the DCT are concentrated around the coefficient of a specific frequency component which is a DC component. Therefore, when the DCT data 21 is quantized by a quantizer 22, of the DCT data 21, only the coefficients concentrated around the coefficient of the specific frequency component remain. Quantized data 23 quantized by the quantizer 22 is input to an inverse quantizer 24 and a variable length coder 25.

The inverse quantizer 24 performs inverse quantization reverse to quantization performed by the quantizer 22 to generate inverse quantized data 26 corresponding to the DCT data 21. The inverse quantized data 26 is supplied to an inverse DCT circuit 27. The inverse DCT circuit 27 performs inverse DCT corresponding to the DCT performed by the DCT circuit 20 to generate an inverse DCT data 28. The inverse DCT data 28 is input to the adder 18. The adder 18 adds the inverse DCT data 28 and the motion-compensated motion image data 17 to each other to generate a local decoded motion image data 29. The local decoded motion image data 29 is input to the frame memory 13. The local decoded motion image data 29 is output as the local decoded motion image data 14 of the previous frame at the next frame timing.

The variable length coder 25 performs static information compression on the basis of the quantized data 23 and the motion vector 15 to output coding output data 30.

The ME 11 detects the motion vector 15 representing the positional relationship between the same images in the frames of the motion image input data 10 and the local decoded data 14. The MC 16 generates the motion-compensated motion image data 17. Here, the compensation motion image data 17 is a predictive motion image data based on the motion vector 15. The subtractor 12 generates the inter-frame differential data 19 between the motion-compensated motion image data 17 and the motion image input data 10. More specifically, with reference to the motion-compensated motion image data 17, only the difference can be calculated. In this manner, redundancy in the direction of a time axis of information to be transmitted is reduced.

In addition, in the conventional motion image coding device, the DCT circuit 20 performs DCT to the inter-frame differential data 19. The characteristics of motion image data in which the cosine functions of the transformed frequency components are related to each other are used. The quantizer 22 performs quantization to remove the frequency components of the cosine functions which are decoded without affecting the image quality. In this manner, the amount of the DCT data 21 to be transmitted is further reduced. The variable length coder 25 performs static information compression to the DCT data 21 and the motion vector 15 output from the quantizer 22 to transmit the compressed DCT data 21 and the compressed motion vector 15. In this manner, redundancy in the direction of a time axis of information to be transmitted is reduced.

The coding output data 30 coded as described above is transmitted through, e.g., an ISDN or an IP network and received by a motion image decoding device. The motion image decoding device performs variable length decoding, inverse quantization, inverse DCT, and motion compensation in a procedure reverse to that of the motion image coding device to decode the received motion image.

However, in the conventional motion image coding device, for example, when a camera motion image under illumination obtained by a fluorescent having a flicker (to be referred to flicker hereinafter), even though an object does not move, an inter-frame difference signal caused by a change in luminance with time is generated. The same operation as described above is performed in the decoding device.

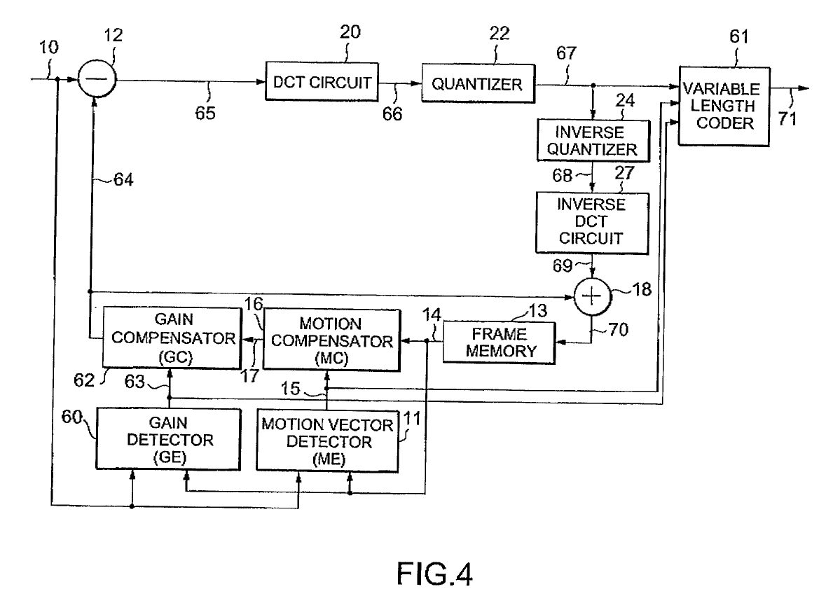

An embodiment of the present invention will be described below. FIG. 4 shows the outline of the configuration of a motion image coding device according to an embodiment of the present invention. The same reference numerals as in the conventional motion image coding device in FIG. 1 denote the same parts in FIG. 4, and a description thereof will be appropriately omitted. The motion image coding device in this embodiment performs motion compensative inter-frame coding in units of divided small blocks on the basis of a motion vector detected from motion image input data and local decoded motion image data of a previous frame.

At this time, a luminance gain at which an inter-frame difference signal are minimum is calculated for a small block in which a larger inter-frame difference signal is generated although the motion vector is zero. Inter-frame compensation is performed by the difference between the local decoded motion image data of the previous frame compensated by the luminance gain and the motion image input data. The calculated luminance gain is transmitted. The motion image coding device in the embodiment described above will be described below.

The motion image input data 10 is obtained by dividing a motion image to be transmitted into predetermined small blocks. The motion image input data 10 is input to an ME 11, a subtractor 12, and a gain detector (Gain Estimation: to be referred to as a GE hereinafter) 60. The ME 11 detects a motion vector 15 from the motion image input data 10 and local decoded motion image data 14 of a previous frame stored in a frame memory 13. The detected motion vector 15 is input to the MC 16 and a variable length coder 61.

The MC 16 compensates for the local decoded motion image data 14 of the previous frame by the motion vector 15 to output the local decoded motion image data 14 as motion-compensated motion image data 17. The motion-compensated motion image data 17 is input to a gain compensator (Gain Compensator: to be referred to as a CC hereinafter) 62.

The GE 60 multiplies luminance signal pixels of the local decoded motion image data 14 converted into a small block by a trial gain G(x) falling within a certain range. The GE 60 calculates a trial gain at which an evaluation value between the local decoded motion image data 14 multiplied by the trial gain G (x) and the motion image input data 10 converted into a small block are minimum. The GE 60 detects a coefficient which must compensate for the local decoded motion image data 14 at this time as a luminance gain 63. The luminance gain 63 is output. The luminance gain 63 is input to the GC 62 and the variable length coder 61.

The GC 62 performs gain compensation to the motion-compensated motion image data 17 by using the luminance gain 63 when the motion vector 15 detected by the ME 11 is a zero vector, and outputs the motion-compensated motion image data 17 as gain-compensated motion image data 64. More specifically, the GC 62 directly output the motion-compensated motion image data 17 to which motion compensation is performed by the MC 16 as the gain-compensated motion image data 64 when the motion vector 15 detected by the ME 11 is not a zero vector. When the motion vector 15 is a zero vector, the motion-compensated motion image data 17 to which motion compensation is performed by the MC 16 is equal to the local decoded motion image data 14 of the previous frame. The GC 62 outputs compensated motion image data obtained by performing gain compensation to the local decoding motion image data 14 of the previous frame by the luminance gain 63 as the gain-compensated motion image data 64. The gain-compensated motion image data 64 is input to the subtractor 12 and an adder 18.

The subtractor 12 calculates a difference between the motion image input data 10 and the gain-compensated motion image data 64 and supplies the difference to a DCT circuit 20 as an inter-frame differential data 65. In this manner, a DCT data 66 converted as the coefficients of the cosine functions of the frequency components is obtained from the inter-frame differential data 65. It is known that a natural image has close frequency components for pixels. The coefficients obtained by the DCT are concentrated around the coefficient of a specific frequency component which is a DC component. Therefore, when the DCT data 66 is quantized by a quantizer 22, only the coefficients concentrated around the coefficient of the specific frequency component remain. Quantized data 67 quantized by the quantizer 22 is input to an inverse quantizer 24 and a variable length coder 61.

The inverse quantizer 24 performs inverse quantization reverse to quantization performed by the quantizer 22 to generate inverse quantized data 68 corresponding to the DCT data 66. The inverse quantized data 68 is supplied to an inverse DCT circuit 27. The inverse DCT circuit 27 performs inverse DCT corresponding to the DCT performed by the DCT circuit 20 to generate an inverse DCT data 69. The inverse DCT data 69 is input to the adder 18. The adder 18 adds the inverse DCT data 69 and the motion-compensated motion image data 64 to each other to generate a local decoded motion image data 70. The local decoded motion image data 70 is input to the frame memory 13. The local decoded motion image data 70 is output as the local decoded motion image data 14 of the previous frame at the next frame timing.

The variable length coder 61 performs static information compression on the basis of the quantized data 67, the motion vector 15, and the luminance gain to output coded output data 71.

The ME 11 divides the motion image input data 10 and the local decoded motion image data 14 of the previous frame stored in the frame memory 13 into, e.g., 16×16 small blocks. The ME11 detects motion vectors 15 for the respective divided small blocks. The motion vectors 15 are represented by MV(x,y), the motion image input data 10 divided into the small blocks are represented by A(i,j), and the local decoded motion image data 14 of the previous frame divided into the small blocks are represented by B(i,j). By calculating (x,y) at which a sum of difference absolute values expressed by the following equation (1) is minimum, the motion vector 15 can be calculated.

MV(x,y)=min(Σ|A(i,j)−B(i+x,j+y)|) (1)

Here, when the minimum sum of difference absolute values expressed by Equation (1) is MV(0,0), the motion vector 15 is zero. This unit that an object in a small block does not move.

The MC 16 performs motion compensation by using the motion vector 15 detected on the basis of the local decoded motion image data 14 of the previous frame stored in the frame memory 13, so that the motion-compensated motion image data 17 which is predictive motion image data.

On the other hand, the GE 60 detects the luminance gains 63 for the respective small blocks on the basis of the motion image input data 10 and the local decoded motion image data 14 of the previous frame stored in the frame memory 13. The luminance gains 63 are output. For example, with respect to A(i,j) which represents the motion image input data 10 converted into a small block and B(i,j) which is the local decoded motion image data 14 of the previous frame converted into a small block, by using an evaluation function expressed by the following Equation (2), a trial gain at which the evaluation value of the evaluation function is minimum is calculated. Subsequently, the local decoded motion image data 14 at this time is detected by using a coefficient g(x) to be compensated as the luminance gain 63.

G(X)=min(Σ|A(i,j)−g(x)·B(i,j)|) (2)

Here, searching for an optimum gain G(i) is performed by high-speed searching using tree searching (tree binary research) of ±0.5, ±0.25, . . . In addition, it is assumed that g(x) is searched for in a range expressed by Equation (3).

0.5≦g(x)≦2.0 (3)

When the motion vector 15 detected by the ME 11 is a zero vector, the GC 62 multiplies the motion-compensated motion image data 17 which is equal to the local decoded motion image data 14 of the previous frame by the luminance gain 63 detected as described above to generate gain-compensated motion image data 64.

The subtractor 12 calculates an inter-frame difference between the gain compensation motion image data 64 and the motion image input data 10. In this manner, with reference to the gain-compensated motion image data 64, an inter-frame differential data 65 from which a redundant component of a change in motion image signal level is removed is generated. The inter-frame differential data 65 includes spatial redundancy which is removed by DCT performed by the DCT circuit 20 and quantization performed by the quantizer 22. The generated quantized data 67 is to which inverse quantization and inverse DCT are performed, which is orthogonal inverse transform by the inverse quantizer 24 and the inverse DCT circuit 27. The adder 18 adds the inter-frame differential data 69 to which inverse DCT are performed to the gain-compensated motion image data 64 to generate local decoded motion image data 70. The local decoded motion image data 70 is stored in the frame memory 13 to code the next frame.

The variable length coder 61 performs static information compression to the quantized data 67 from which time redundancy and spatial redundancy are removed, the motion vector 15 detected by the ME 11, and the luminance gain 63 detected by the GE 60. This static information compression statically analyzes generation frequencies of data patterns to which information compression is to be performed, and assigns a short code word to data having a high generation frequency and assigns a long code word to data having a low generation frequency. The variable length coder 61 outputs a code word string consisting of a Huffman code as the coded output data 71.

The coded output data 71 coded as described above is transmitted through, e.g., an ISDN or an IP network and received by a motion image decoding device.

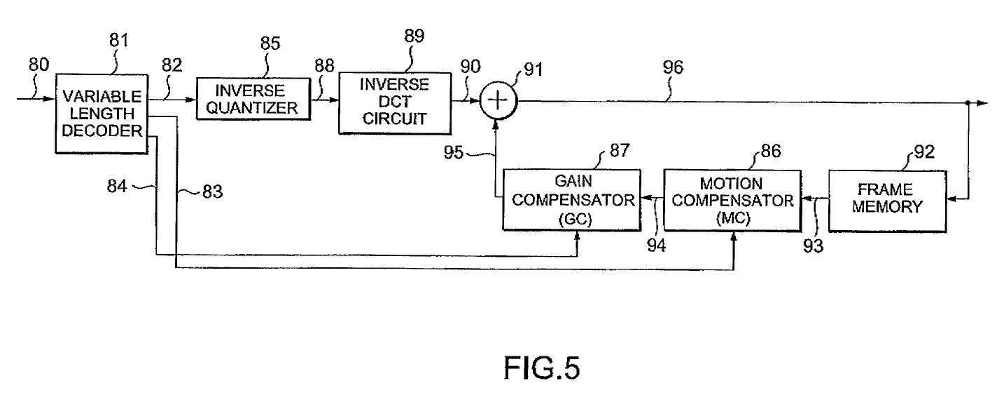

FIG. 5 shows the outline of the configuration of a motion image decoding device for receiving and coding information coded by the motion image coding device according to this embodiment shown in FIG. 4. Variable length coded data 80 coded and transmitted by the motion coding device is input to a variable length decoder 81. The variable length decoder 81 decodes and separates coded motion image data 82, a motion vector 83, and a luminance gain 84 by a decoding process corresponding to the coding process performed by the variable length coder 61 shown in FIG. 4 on the basis of the input variable length coded data 80. The separated coded motion image data 82 is input to an inverse quantizer 85. The separated motion vector 83 is input to an MC 86. The separated luminance gain 84 is input to a GC 87.

The inverse quantizer 85, like the inverse quantizer 24 of the motion image coding device shown in FIG. 4, performs inverse quantization corresponding to the quantizing process performed by the quantizer 22 to transfer the coded motion image data 82 into inverse quantized data 88 which represents coefficients of the cosine functions of frequency components obtained by DCT, and outputs the inverse quantized data 88. The inverse quantized data 88 is input to an inverse DCT circuit 89.

The inverse DCT circuit 89, like the inverse DCT circuit 27 of the motion image coding device shown in FIG. 4, performs inverse DCT corresponding to DCT performed by the DCT circuit 20 to transfer the inverse quantized data into inverse DCT data 90 which represents motion image data for respective small blocks, and outputs the inverse DCT data 90. The inverse DCT data 90 is input to an adder 91.

On the other hand, the MC 86 performs motion compensation by using the motion vector 83 separated by the variable length decoder 81 on the basis of local decoded motion image data 93 of a previous frame stored in a frame memory 92 to generate motion-compensated motion image data 94. This motion-compensated motion image data 94 is input to the GC 87. The GC 87 multiplies the motion-compensated motion image data 94 by the luminance gain 84 separated by the variable length decoder 81 to perform gain compensation, and generates gain-compensated motion image data 95. The gain compensated motion image data 95 is supplied to the adder 91. The adder 91 adds the inverse DCT data 90 and the gain compensated motion image data 95 to each other to generate decoded motion image data 96. The decoded motion image data 96 is output to an image processing device (not shown) and stored in the frame memory 92 to decode the next frame.

As has been described above, in the motion image coding device according to this embodiment, the ME 11 detects the motion vectors 15 for respective divided small blocks on the basis of the motion image input data 10 and the local decoded motion image data 14 of the previous frame stored in the frame memory 13. The GE 60 detects the luminance gain 63 which is a coefficient multiplied to the luminance signal pixels of the local decoded motion image data 14 of the previous frame at which a sum of difference absolute values between the local decoded motion image data 14 and the motion image input data 10 is minimum.

When the detected motion vector 15 is a zero vector, the gain-compensated motion image data 64 obtained such that the luminance gain 63 performs gain compensation to the motion-compensated motion image data 17 to which motion compensation is performed by the MC 16 is generated. The inter-frame differential data 65 is generated with reference to the gain-compensated motion image data 64 to delete time redundancy. Static information compression of the luminance gain 63 and the motion vector 15 is performed by the variable length coder 61. The luminance gain 63 to which static information compression is performed is supplied to the motion image decoding device as a part of the coded output data 71.

The motion image decoding device separates the motion vector 83 and the luminance gain 84 from the received variable length coded data 80. The MC 86 perform motion compensation on the basis of the local decoded motion image data 14 of the previous frame stored in the frame memory 92 and the motion vector 83. The GC 87 performs gain compensation on the basis of the luminance gain 84 and the motion-compensated motion image data 94 from the MC 86. The gain-compensated motion image data 95 from the GC 87 and the decoded data to which inverse quantization and a decoding process are performed by the inverse DCT to generate decoded motion image data 96.

In this manner, when a camera motion image under the illumination of a fluorescent having a flicker is to be coded, although an object does not move, a large inter-frame difference by a change in luminance caused by the flicker can be avoided from being generated Information compensation of a motion image in a severe environment can be efficiently performed.

In the motion image coding device according to this embodiment, when motion compensation by the detected motion vector 15 is performed to the local image coded data 14 of the previous frame stored in the frame memory 13. Thereafter, with reference to the gain-compensated motion image data 64 to which gain compensation is performed by the detected luminance gain 63, the inter-frame differential data 65 between the motion image data 64 and the motion image input data 10 is generated. However, the present invention is not limited to this configuration.

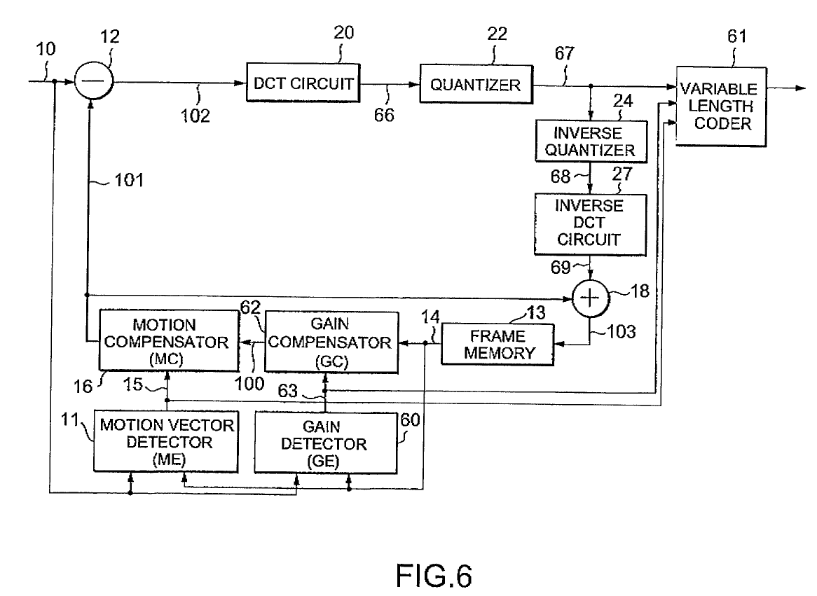

FIG. 6 shows the outline of the configuration of a motion image coding device according to another embodiment of the present invention. The same reference numerals as in the motion image coding device shown in FIG. 4 denote the same parts in FIG. 6, and a description thereof will be omitted. The different point between the motion image coding device according to this embodiment and the motion image coding device shown in FIG. 4 is as follows. That is, after gain compensation performed by the detected luminance gain 63 is performed to the local image coded data 14 of the previous frame stored in the frame memory 13, the inter-frame differential data 65 between the motion-compensated motion image data and the motion image input data 10 is generated on the basis of the motion-compensated motion image data to which motion compensation is performed by the detected motion vector 15.

More specifically, when the motion vector 15 detected by the ME 11 is a zero vector, the GC 62 multiplies the luminance gain 63 detected by the GE 60 to the local decoded motion image data 14 of the previous frame to generate gain-compensated motion image data 100. The gain-compensated motion image data 100 is input to the MC 16. The MC 16 performs motion compensation by using the motion vector 16 detected by the ME 11 to generate the motion-compensated motion image data 101 which is predictive motion image data. The motion-compensated motion image data 101 is supplied to the subtractor 12 and the adder 18. Therefore, the subtractor 12 generates inter-frame differential data 102 between the motion-compensated motion image data 101 and the motion image input data 10 with reference to the motion-compensated motion image data 101 The adder 18 adds the inverse DCT data 69 and the motion-compensated motion image data 101 to each other to generate local decoded motion image data 103. The local decoded motion image data 103 is stored in the frame memory 13 to code the next frame.

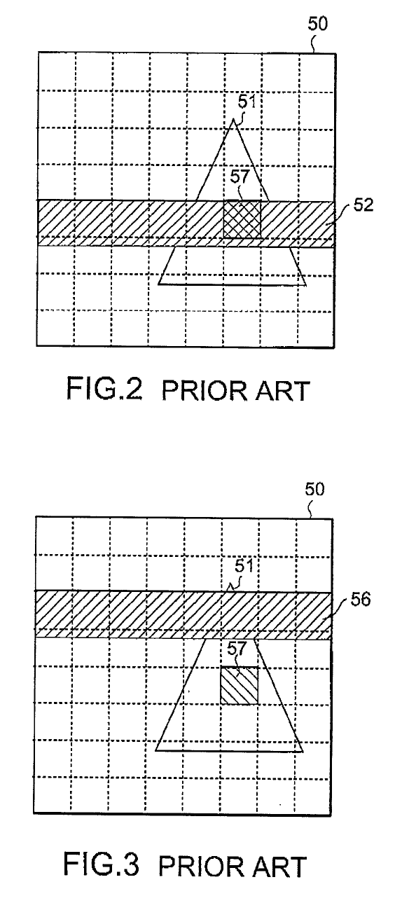

A motion image decoding device for receiving variable length coded data transmitted by the motion image coding device in this embodiment is not illustrated. The motion image decoding device is different from the motion image decoding device in this embodiment shown in FIG. 2 in the following point. The local decoded motion image data 93 of the previous frame stored in the frame memory 92 to which gain compensation is performed by the luminance gain 84 decoded and separated by the GC 87 in the variable length decoder 81. Then, motion compensation of the gain-compensated local decoded motion image data is performed by the motion vector 83 decoded and separated by the MC 86 in the variable length decoder 81. The adder 91 adds the motion-compensated motion image data to which motion compensation and the inverse DCT 90 are performed on the basis of the inverse DCT circuit 89 to each other In this manner, decoded image data is obtained.

The motion image coding and decoding devices according to the embodiments described above are described on the assumption that inverse DCT is performed as orthogonal inverse transform. However, the present invention is not limited to this. For example, Fourier transform, which is another orthogonal transform, Hadamard transform, or wavelet transform and inverse transform corresponding thereto may be performed in the motion image coding and decoding devices.

The motion image coding devices according to the two embodiments are described on the assumption that the luminance gain 63 detected by the GE 60 is coded to be transmitted to the decoding device even though a motion vector is not a zero vector. However, the present invention is not limited to this. For example, the luminance gain 63 may be coded and transmitted to the decoding device only when the motion vector is a zero vector. When the motion vector is not a zero vector, only the motion vector and quantized data may be transmitted to the decoding device as in the conventional technique. For this reason, in the variable length coder 61, variable length coding is performed to the luminance gain and the motion vector including a newly set flag such that the decoding device serving as a transmission source can recognize whether the motion vector and the luminance gain are coded or not. In this manner, an amount of information to be transmitted when the motion vector is a zero vector can be more considerably reduced.

Also, when the motion vector is a zero vector, the luminance gain 63 may be coded in place of the motion vector and transmitted to the decoding device. When the motion vector is a zero vector, only the motion vector and quantized data may be transmitted to the decoding device as in the conventional technique. For this reason, in the variable length coder 61, variable length coding is performed to the luminance gain and the motion vector including a newly set flag such that the decoding device serving as a transmission source can recognize whether the motion vector and the luminance gain are coded or not. In this manner, an amount of information to be transmitted can be more considerably reduced.

The GC 62 in the motion image coding devices according to the two embodiments is described on the assumption that, when the motion vector is not a zero vector, the motion-compensated motion image data 17 to which motion compensation is performed by the MC 16 is directly output as the gain-compensated motion image data 64. The present invention is not limited to this. The gain-compensated motion image data 64 obtained such that the motion-compensated motion image data 17 is subjected to gain compensation by a luminance gain detected by the GE 60 may be output. In this case, unlike the above description, the luminance gain 63 must be transmitted to the decoding device.

As described above, according to the present invention, with respect to a motion image in a severe environment in which a camera motion image under the illumination of a fluorescent having a flicker is coded such that a large change in luminance occurs even though a motion vector is a zero vector, coefficients to be compensated to pixels are detected regardless of the motion vector, and gain compensation is performed. Therefore, although an object does not move, a large inter-frame difference by a change in luminance caused by the flicker can be avoided from being generated. Efficient information compensation can be performed.

In particular, inter-frame differential data is orthogonally transformed by using an orthogonal transform unit, so that coefficients concentrated on a specific transform coefficient are quantized by using a high correlation inherent in motion image data to round the coefficient. For this reason, spatial redundancy can be removed. In addition, since the inter-frame differential data, the motion vector, and the gain are coded depending on the generation frequencies of the inter-frame differential data, the motion vector, and the gain, spatial redundancy is further removed, and an amount of information to be transmitted can be considerably reduced.

Furthermore, since a gain is coded and transmitted only when a motion vector is a zero vector, an amount of information to be transmitted can be further reduced.

Still furthermore, since a gain is coded and transmitted in place of a motion vector when the motion vector is a zero vector, a reduction in an amount of information to be transmitted can be made larger than that in the invention described in the present invention.

What is claimed is:

1. A motion image coding device comprising:
a frame memory for storing motion image data of a previous frame;
motion vector detector for detecting a motion vector representing a spatial difference of pixel values between frames on the basis of input motion image data and the motion image data of the previous frame stored in the frame memory;
gain detector for detecting a gain to be compensated to the motion image data of the previous frame such that changes in luminance of pixels between the frames of the input motion image data and the motion image data of the previous frame are minimum;
gain compensator for performing gain compensation to the motion image data of the previous frame on the basis of the gain detected by the gain detector when the motion vector detected by the motion vector detector is a zero vector;
inter-frame differential data generator for generating inter-frame differential data which is a difference between the input motion image data and the motion image data to which gain compensation is performed by the gain compensator; and
coder for coding the inter-frame differential data generated by the inter-frame differential data generator, the motion vector, and the gain to transmit the coded inter-frame differential data, the coded motion vector, and the coded gain.

2. A motion image coding device comprising:
a frame memory for storing motion image data of a previous frame;
motion vector detector for detecting a motion vector representing a spatial difference of pixel values between frames on the basis of input motion image data and the motion image data of the previous frame stored in the frame memory;
gain detector for detecting a gain to be compensated to the motion image data of the previous frame such that changes in luminance of pixels between the frames of the input motion image data and the motion image data of the previous frame are minimum;
motion compensator for performing motion compensation to the motion image data of the previous frame on the basis of the motion vector detected by the motion vector detector;
gain compensator for performing gain compensation to the motion image data to which gain compensation is performed by the motion compensator on the basis the gain detected by the gain detector;
inter-frame differential data generator for generating inter-frame differential data which is a difference between the input motion image data and the motion image data to which gain compensation is performed by the gain compensator; and
coder for coding the inter-frame differential data generated by the inter-frame differential data generator, the motion vector, and the gain to transmit the coded inter-frame differential data, the coded motion vector, and the coded gain.

3. A motion image coding device as claimed in claim 2, further comprising:
orthogonal transform unit for performing orthogonal transform of inter-frame differential data; and
quantization unit for quantizing the transformed data from the orthogonal transform unit,
wherein the coder codes the quantized data quantized by the quantization unit, the motion vector, and the gain depending on the generation frequencies thereof to transmit the coded quantized data, the coded motion vector, and the coded gain.

4. A motion image decoding device as claimed in claim 3, wherein the coder codes a gain to transmit the coded gain only when the motion vector is a zero vector.

5. A motion image decoding device as claimed in claim 3, wherein the coder codes the gain in place of the motion vector to transmit the coded gain when the motion vector is a zero vector.

6. A motion image decoding device comprising:
a frame memory for storing motion image data of a previous frame;
extraction unit for extracting, from input code data, coded motion image data, a motion vector representing a spatial difference of pixel values between the coded motion image data and motion image data of the previous frame, and a gain to be compensated to the motion image data of the previous frame such that changes in luminance of pixels between the coded motion image data and the motion image data of the previous frame are minimum;
gain compensator for performing gain compensation to the motion image data of the previous frame on the basis of the gain when the motion vector extracted by the extraction unit is a zero vector; and
decode motion image data generator for generating decoded motion image data on the basis of the motion image data to which gain compensation is performed by the gain compensator and the coded motion image data.

7. A motion image decoding device comprising:
a frame memory for storing motion image data of a previous frame;
extraction unit for extracting, from input code data, coded motion image data, a motion vector representing a spatial difference of pixel values between the coded motion image data and motion image data of the previous frame, and a gain to be compensated to the motion image data of the previous frame such that changes in luminance of pixels between the coded motion image data and the motion image data of the previous frame are minimum;
motion compensator for performing motion compensation for the motion image data of the previous frame on the basis of the motion vector extracted by the extraction unit;
gain compensator for performing gain compensation to the motion image data to which motion compensation is performed by the motion compensator; and
decode motion image data generator for generating decoded motion image data on the basis of the motion image data to which gain compensation is performed by the gain compensator and the coded motion image data.

8. A motion image decoding device as claimed in claim 6 or 7, further comprising:
inverse quantization unit for inversely quantizing coded motion image data extracted by the extraction unit; and
orthogonal inverse transform unit for performing orthogonal transform to the inversely quantized data which is inversely quantized by the inverse quantization unit,
wherein the decode motion image data generator generates decoded motion image data on the basis of the motion image data to which orthogonal inverse transform is performed by the orthogonal transform unit and the motion image data to which gain compensation is performed by the gain compensator.
